(19) United States
(12) Patent Application Publication
(10) Pub. No.: US 2009/0225794 A1
(43) Pub. Date: Sep. 10, 2009

(54) High Energy All Fiber Mode Locked Fiber Laser

(76) Inventor: Jian Liu, Sunnyvale, CA (US)

Correspondence Address: JOHN MARTIN TABOADA, 1923 N. NEW BRAUNFELS, SAN ANTONIO, TX, 78208, US

(21) Appl. No.: 12/400,780

(22) Filed: Mar. 9, 2009

Related U.S. Application Data
(60) Provisional application No. 61/068,750, filed on Mar. 10, 2008.
(60) Provisional application No. 61/068,835, filed on Mar. 10, 2008.

(51) Int. Cl. H01S 3/30

(52) U.S. Cl. 372/6

(57) ABSTRACT

Methods and systems for generating high energy, ultra-short laser pulses are disclosed, including generating electromagnetic radiation from a pump laser; coupling the pump laser electromagnetic radiation to a Ytterbium doped fiber using a WDM coupler; coupling the output from the Ytterbium doped fiber to a first single mode fiber; coupling a bandpass filter to the first single mode fiber output and to a second single mode fiber; coupling a first in-line polarization controller to the second single mode fiber output and an in-line polarization beam splitter comprising a single mode fiber output and a polarization maintaining fiber output configured to emit an output laser pulse; coupling a polarization insensitive isolator to the single mode fiber output of the in-line polarization beam splitter and to a second in-line polarization controller; coupling a third single mode fiber output to the second in-line polarization controller and to the WDM coupler; coupling the output laser pulse to a preamplifier; coupling the preamplifier output to a high power amplifier; and coupling the high power amplifier output to a compressor.

The inventor claims priority to provisional patent application No. 61/068,835 filed on Mar. 10, 2008 and provisional patent application No. 61/068,750 filed on Mar. 10, 2008.

### BACKGROUND

The invention relates generally to the field of using an all fiber ring cavity laser for generating ultra-short high power and high energy laser pulses.

### SUMMARY

In one respect, disclosed is a self-start, seed, mode locked fiber laser comprising: a pump laser; a WDM coupler to couple the pump laser into a Ytterbium doped fiber, where the Ytterbium doped fiber is coupled into a first single mode fiber; a bandpass filter coupled to the first single mode fiber output and to a second single mode fiber; a first in-line polarization controller coupled to the second single mode fiber output and an in-line polarization beam splitter, where the in-line polarization beam splitter comprises a single mode fiber output and a polarization maintaining fiber output, where the polarization maintaining fiber is configured for an output laser pulse; a polarization insensitive isolator coupled to the single mode fiber output of the in-line polarization beam splitter; a second in-line polarization controller coupled to the polarization insensitive isolator and a third single mode fiber, where the third single mode fiber output is coupled into the WDM coupler.

In another respect, disclosed is a high energy, ultra-short, mode locked fiber laser system comprising: a seed laser comprising: a pump laser; a WDM coupler to couple the pump laser into a Ytterbium doped fiber, where the Ytterbium doped fiber is coupled into a first single mode fiber; a bandpass filter coupled to the first single mode fiber output and to a second single mode fiber; a first in-line polarization controller coupled to the second single mode fiber output and an in-line polarization beam splitter, where the in-line polarization beam splitter comprises a single mode fiber output and a polarization maintaining fiber output, where the polarization maintaining fiber is configured for an output laser pulse; a polarization insensitive isolator coupled to the single mode fiber output of the in-line polarization beam splitter; a second in-line polarization controller coupled to the polarization insensitive isolator and a third single mode fiber, where the third single mode fiber output is coupled into the WDM coupler where the seed laser is configured to couple the output laser pulses to a preamplifier; a high power amplifier coupled to the output of the preamplifier; and a compressor coupled to the output of the high power amplifier.

In yet another respect, disclosed is a method for generating high energy, ultra-short laser pulses, the method comprising: generating electromagnetic radiation from a pump laser; coupling the pump laser electromagnetic radiation to a Ytterbium doped fiber using a WDM coupler; coupling the output from the Ytterbium doped fiber to a first single mode fiber; coupling a bandpass filter to the first single mode fiber output and to a second single mode fiber; coupling a first in-line polarization controller to the second single mode fiber output and an in-line polarization beam splitter comprising a single mode fiber output and a polarization maintaining fiber output configured to emit an output laser pulse; coupling a polarization insensitive isolator to the single mode fiber output of the in-line polarization beam splitter and to a second in-line polarization controller; coupling a third single mode fiber output to the second in-line polarization controller and to the WDM coupler; coupling the output laser pulse to a preamplifier; coupling the preamplifier output to a high power amplifier; and coupling the high power amplifier output to a compressor.

Numerous additional embodiments are also possible.

### BRIEF DESCRIPTION OF THE DRAWINGS

Other objects and advantages of the invention may become apparent upon reading the detailed description and upon reference to the accompanying drawings.

FIG. 1 is a block diagram illustrating a seed all fiber mode locked fiber laser, in accordance with some embodiments.

FIG. 2 is a graph showing the repetition rate as a function of fiber length in a ring laser cavity, in accordance with some embodiments.

FIG. 3 is a graph showing the chirped pulse width as a function of the fiber cavity length and the bandpass filter bandwidth, in accordance with some embodiments.

FIG. 4 is a schematic showing the details of the polarization beam splitter using a polarization cube, in accordance with some embodiments.

FIG. 5 is a schematic showing the details of the polarization beam splitter using a birefringence crystal, in accordance with some embodiments.

FIG. 6 is a block diagram illustrating a conventional chirped pulse amplification fiber laser system and an all fiber, high energy, ultra-short, mode locked fiber laser system without a pulse picker and fiber stretcher, in accordance with some embodiments.

FIG. 7 is a flow diagram illustrating a method to generate ultra-short high power laser pulses, in accordance with some embodiments.

While the invention is subject to various modifications and alternative forms, specific embodiments thereof are shown by way of example in the drawings and the accompanying detailed description. It should be understood, however, that the drawings and detailed description are not intended to limit the invention to the particular embodiments. This disclosure is instead intended to cover all modifications, equivalents, and alternatives falling within the scope of the present invention as defined by the appended claims.

### DETAILED DESCRIPTION

One or more embodiments of the invention are described below. It should be noted that these and any other embodiments are exemplary and are intended to be illustrative of the invention rather than limiting. While the invention is widely applicable to different types of systems, it is impossible to include all of the possible embodiments and contexts of the invention in this disclosure. Upon reading this disclosure, many alternative embodiments of the present invention will be apparent to persons of ordinary skill in the art.

In some embodiments, an all fiber mode locked laser can generate mode locked femtosecond and picosecond pulses by utilizing components for polarization and spectral shaping. By varying the fiber cavity length, the repetition rate can vary from 100 MHz to 50 Khz and by also adjusting the position of the output coupler, the pulse width can range from 200 femtoseconds to 1 nanosecond. Such a low repetition rate laser can be used as the seed for a high energy mode locked fiber laser system at 1 micron, thus eliminating the need for a pulse picker, stretcher, and a couple of stages of amplifiers.

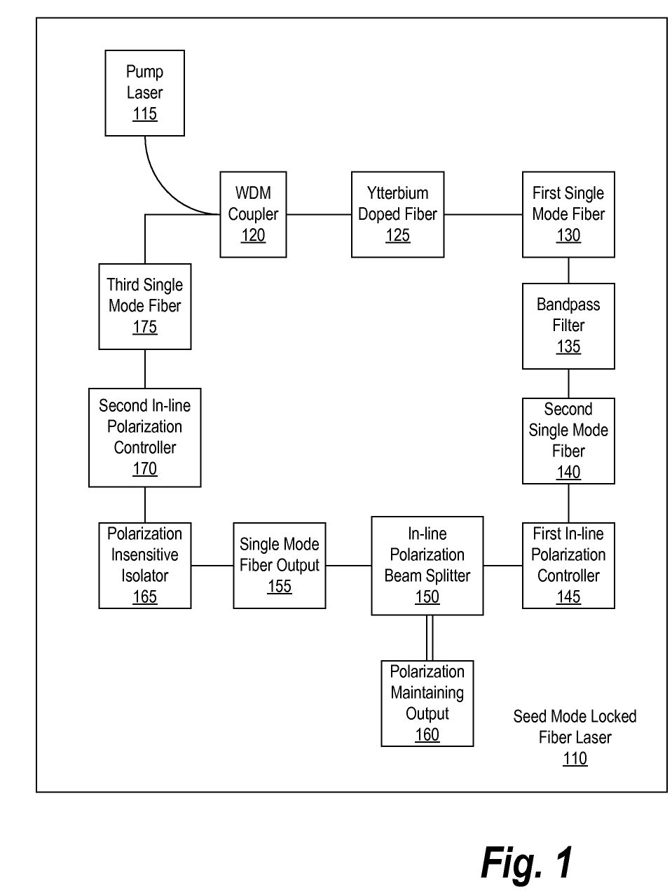

FIG. 1 is a block diagram illustrating a seed all fiber mode locked fiber laser, in accordance with some embodiments.

In some embodiments, a seed mode locked fiber laser 110 comprises a pump laser 115 coupled with a WDM coupler 120. The WDM coupler 120 couples the pump laser 115 into the gain medium of Ytterbium doped fiber 125. The output from the Ytterbium doped fiber 125 is coupled into a first single mode fiber 130. The output of the first single mode fiber 130 is coupled into bandpass filter 135. The bandpass filter 135 is then coupled to a second single mode fiber 140 that is then coupled to a first in-line polarization controller 145. The output of the first in-line polarization controller 145 is then coupled with an in-line polarization beam splitter 150 having a single mode fiber output 155 and a polarization maintaining output 160. The single mode fiber output 155 is then coupled with a polarization insensitive isolator 165. A second in-line polarization controller 170 is then connected to the polarization insensitive isolator 165. The output of the second in-line polarization controller 170 is then coupled into a third single mode fiber 175. The output of the third single mode fiber 175 is then coupled back into the WDM coupler 120, thus completing the all fiber ring cavity.

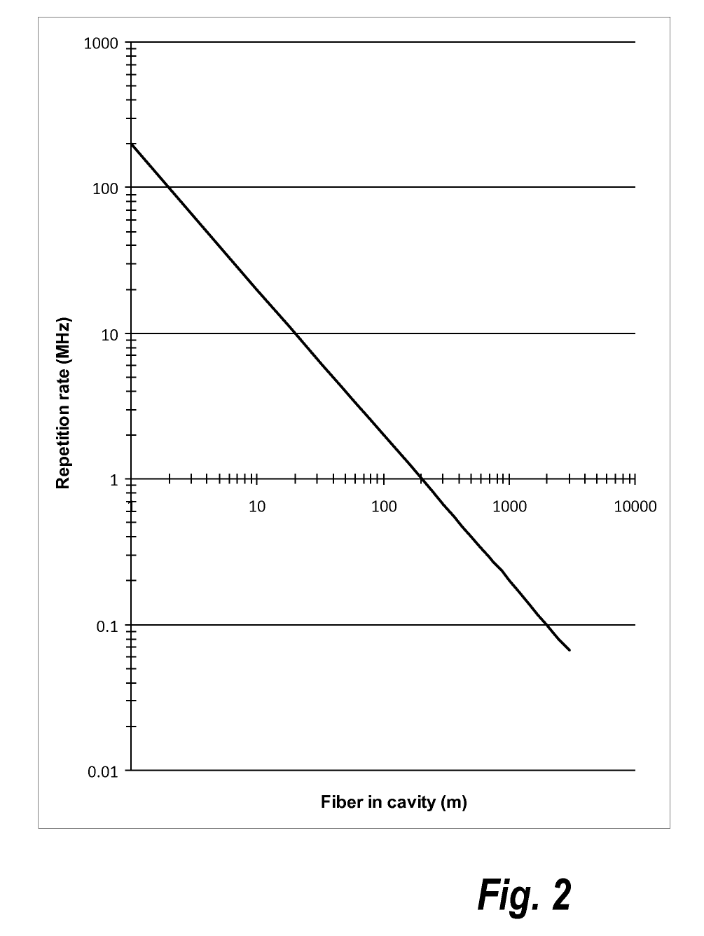

FIG. 2 is a graph showing the repetition rate as a function of fiber length in a ring laser cavity, in accordance with some embodiments.

In some embodiments, the pulse repetition rate can be lowered by using a longer fiber cavity length. A 20 m fiber in the cavity will result in a pulse repetition rate of 10 MHz; whereas a 2 km fiber cavity will result in a pulse repetition rate of 100 kHz. Thus by using a longer fiber in the cavity and lowering the pulse repetition rate in the seed laser, the need for using a pulse picker in the overall laser system is eliminated.

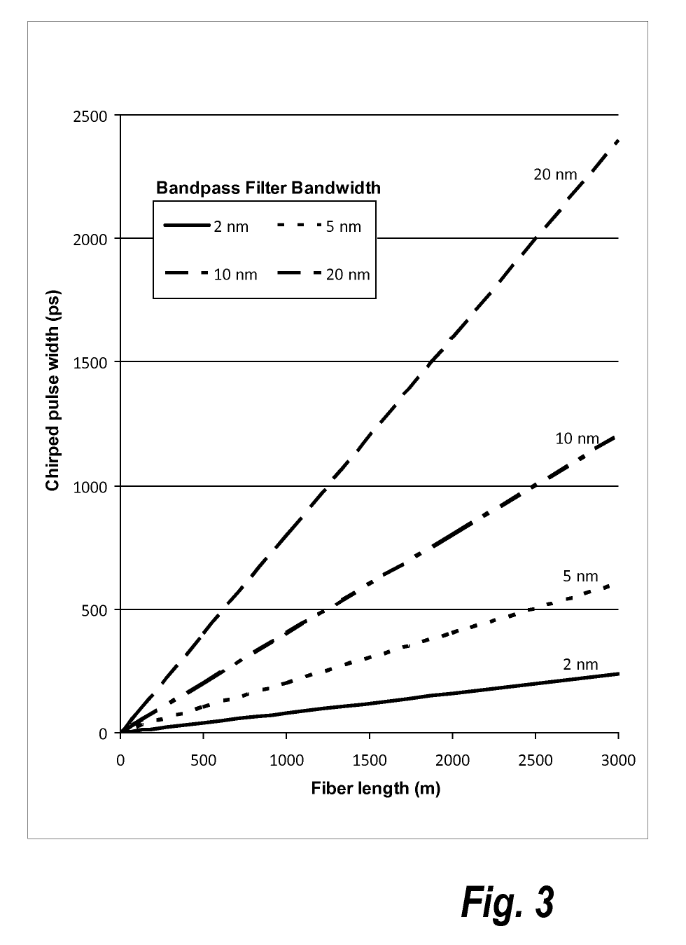

FIG. 3 is a graph showing the chirped pulse width as a function of the fiber cavity length and the bandpass filter bandwidth, in accordance with some embodiments.

In some embodiments, the need for a stretcher in a high power, high energy ultra-short fiber laser system can be eliminated by using a longer fiber cavity in the seed along with a bandpass filter within the ring cavity of the seed laser. FIG. 3 shows the dependence of the chirped pulse width as a function of the fiber length in the cavity of the seed laser and the bandwidth of the bandpass filter of the seed laser, assuming a cavity with only the second single mode fiber 140 and without the first single mode fiber 130 and third single mode fiber 175. The chirped pulse width increases with increasing cavity fiber length and broader bandwidth of bandpass filter.

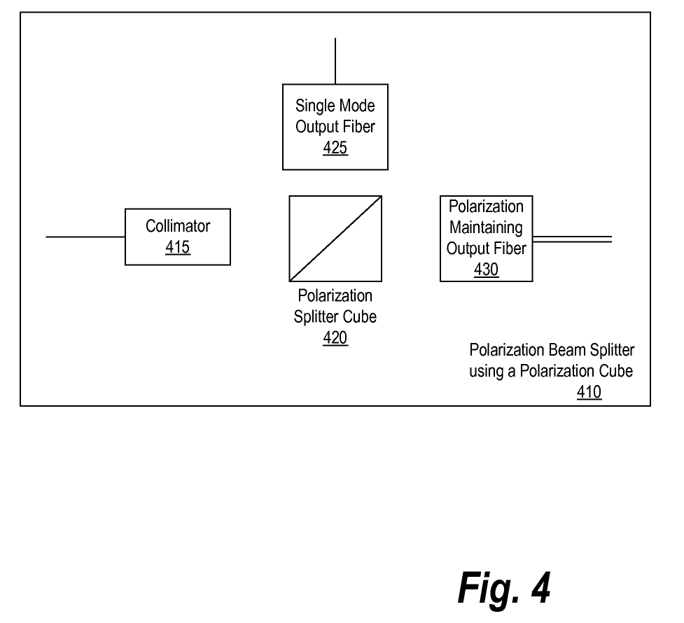

FIG. 4 is a schematic showing the details of the polarization beam splitter using a polarization cube, in accordance with some embodiments.

In some embodiments, the polarization beam splitter 410 is of a special design. In conventional polarization beam splitters, the two output fibers consist of polarization maintaining fibers. In the special design for the polarization beam splitter 410, the collimator 415 from the input fiber hits a polarization splitter cube 420 and then splits the beam into one single mode fiber 425 and a polarization maintaining fiber 430. The single mode fiber output 425 is coupled back into the ring cavity of the all fiber seed laser. This insures a stable mode locking mechanism. The polarization maintaining output fiber 430 is used as the seed for the high energy ultra-short fiber laser system.

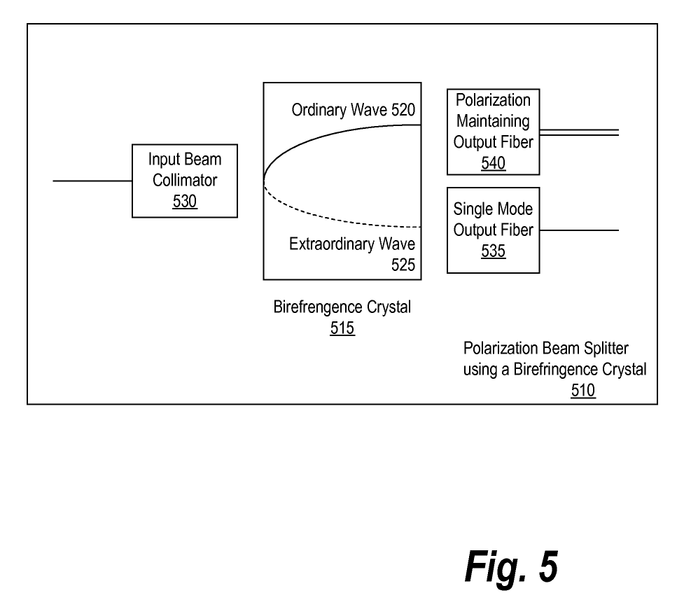

FIG. 5 is a schematic showing the details of the polarization beam splitter using a birefringence crystal, in accordance with some embodiments.

In some embodiments, polarization beam splitter 510 uses the double refraction of a birefringence crystal 515 to generate an ordinary wave 520 and an extraordinary wave 525 from a single collimated input beam 530. The split beams are coupled into two output fibers, one single mode fiber 535 and the other polarization maintaining fiber 540.

As in output fibers from the polarization beam splitter using a polarization cube, the single mode fiber 535 is coupled into the ring cavity and the polarization maintaining fiber 540 is used as the polarized laser output from the seed.

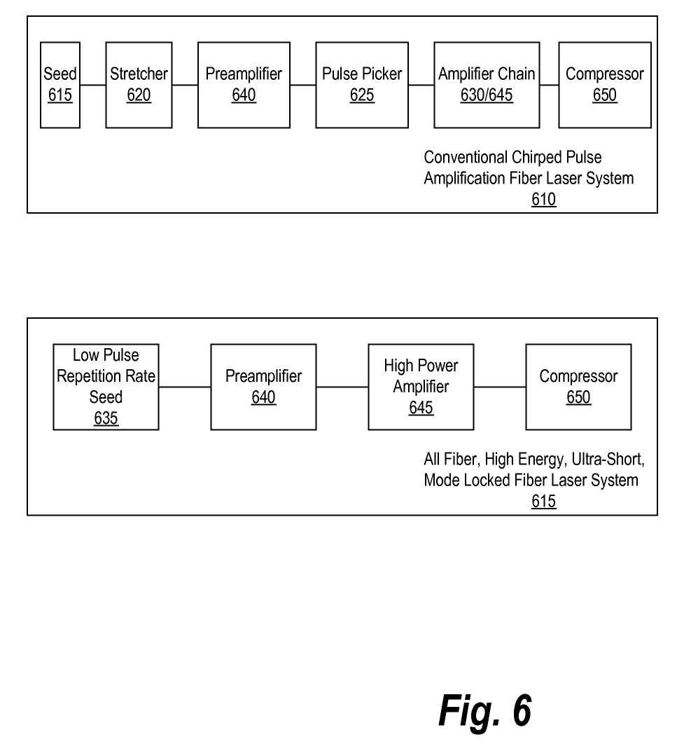

FIG. 6 is a block diagram illustrating a conventional chirped pulse amplification fiber laser system and an all fiber, high energy, ultra-short, mode locked fiber laser system without a pulse picker and fiber stretcher, in accordance with some embodiments.

In some embodiments, the conventional chirped pulse amplification fiber laser system 610 consists of a standard seed laser 615 having narrow pulses with pulse repetition rates of 20 Mz to 200 Mz thus requiring a stretcher 620, a pulse picker 625, and an amplifier chain 630, including a high power amplifier 645, in order to achieve a high energy, ultra-short, mode locked fiber laser system. By using a low pulse repetition rate seed laser 635, the stretcher 620, pulse picker 625, and a couple amplifier stages of the amplifier chain 630 can be eliminated from the conventional chirped pulse amplification fiber laser system. In both systems, a preamplifier 640, a high power amplifier 645, and compressor 650 are still utilized. The preamplifier may include one or two stages of Ytterbium doped fiber amplifiers. Depending on the desired output energy levels, microjoules or millijoules, one or two high power amplifiers may be used. The compressor can either be a grating or fiber type.

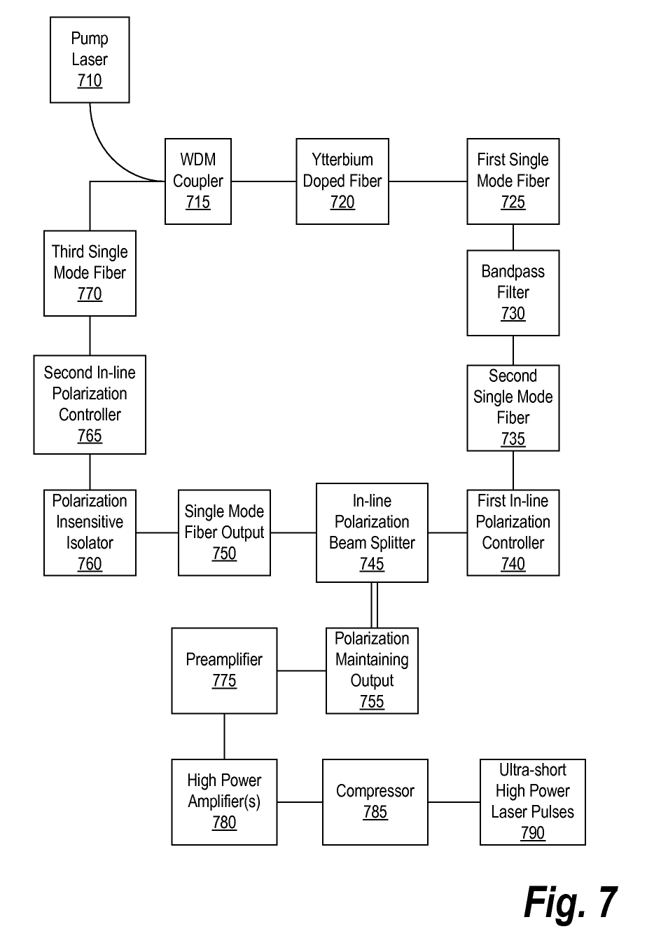

FIG. 7 is a flow diagram illustrating a method to generate ultra-short high power laser pulses, in accordance with some embodiments. In some embodiments, the method illustrated in FIG. 7 may be performed by one or more of the devices illustrated in FIG. 1, FIG. 4, FIG. 5, and FIG. 6.

Processing begins with a 980 nm laser pump diode 710 coupled into a WDM 715. The WDM 715 may either be a 980/1030 or 980/1060 WDM coupler. The WDM 715 is then coupled into a gain medium of Ytterbium doped fiber 720 having a high doping concentration ranging between 10,000 ppm to 2,000,000 ppm. The Ytterbium doped fiber 720 amplifies the pulses circulating in the cavity. A first single mode fiber 725, such as HI 1060 fiber or SM 25, is coupled to the output of the Ytterbium doped fiber 720. After the first single mode fiber 725, a bandpass filter 730 is used to select the wavelength and stabilize the mode locking of the ring cavity. The bandpass filter 730 has a bandwidth between 1 nm to 20 nm. A second single mode fiber 735, such as HI 1060 fiber or SM 25, follows the bandpass filter 730. Next a first fiber based in-line polarization controller 740 is used to control the polarization of the pulse before entering an in-line polarization beam splitter 745. When the pulse passes through the polarization beam splitter 745, only the highest intensity lined up with the splitter will pass and the lower intensity part of the pulse will be filtered. This results in the pulse being shaped and works as a saturable absorber to induce mode locking. The in-line polarization beam splitter 745 may either split the beam using a polarization splitter cube or a birefringence crystal. In both cases, the beam is split into a single mode fiber 750 that is coupled back into the ring of the cavity to insure a stable mode-locking mechanism and a polarization maintaining fiber output 755 to be used as the seed laser in high energy, ultra-short, mode locked fiber laser system. The non-polarization maintaining single mode output fiber 750 from the in-line polarization beam splitter 745 is coupled to a polarization insensitive isolator 760. The polarization insensitive isolator 760 is used in the ring cavity to insure unidirectional propagation. A second in-line polarization controller 765 follows the isolator 760. Finally a third single mode fiber 770, such as HI 1060 fiber or SM 25, completes the ring cavity by coupling the second in-line polarization controller 765 to the WDM 715.

The just described all fiber seed laser is polarized, self start, and operates at all normal dispersion and without any anomalous dispersion (B″<0) components to achieve stable mode locking pulses with a pulse repetition rate between 50 kHz to 100 MHz. The mode lock mechanism is created by both polarization shaping, due to self phase modulation induced polarization change, and spectral shaping resulting from the bandwidth of the band pass filter. By adjusting the position and lengths of the three single mode fiber segments, the chirped output width can vary from 1 to 30,000 times the dechirped pulse width. The output pulse width can be chirped from 100 fs to 3 ns and the chirped output pulses can be dechirped from 10 fs to 10 ps. The total fiber length in the cavity can range from 1 m to 3000 m. The output spectrum bandwidth of the seed laser ranges from 0.5 nm to 30 nm and has a center lasing wavelength between 1025 nm to 1100 nm.

In order to generate ultra-short high power laser pulses, the polarized output from the seed laser 755 is first coupled into a preamplifier 775 consisting of one or two stages of Ytterbium doped fibers. Next, depending on the desired output energy levels of microjoules or millijoules, the preamplifier 775 is coupled to one or two high power amplifiers 780, respectively. Finally, the pulses are compressed using either a grating or fiber type compressor 785, resulting in ultra-short high power laser pulses 790.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

The benefits and advantages that may be provided by the present invention have been described above with regard to specific embodiments. These benefits and advantages, and any elements or limitations that may cause them to occur or to become more pronounced are not to be construed as critical, required, or essential features of any or all of the claims. As used herein, the terms “comprises,” “comprising,” or any other variations thereof, are intended to be interpreted as non-exclusively including the elements or limitations which follow those terms. Accordingly, a system, method, or other embodiment that comprises a set of elements is not limited to only those elements, and may include other elements not expressly listed or inherent to the claimed embodiment.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention as detailed within the following claims.

1. A self-start, seed, mode locked fiber laser comprising:
a pump laser;
a WDM coupler to couple the pump laser into a Ytterbium doped fiber, where the Ytterbium doped fiber is coupled into a first single mode fiber;
a bandpass filter coupled to the first single mode fiber output and to a second single mode fiber;
a first in-line polarization controller coupled to the second single mode fiber output and an in-line polarization beam splitter, where the in-line polarization beam splitter comprises a single mode fiber output and a polarization maintaining fiber output, where the polarization maintaining fiber is configured for an output laser pulse;
a polarization insensitive isolator coupled to the single mode fiber output of the in-line polarization beam splitter;
a second in-line polarization controller coupled to the polarization insensitive isolator and a third single mode fiber, where the third single mode fiber output is coupled into the WDM coupler.

2. The self start, seed, mode locked fiber laser of claim 1, where the output laser pulse has a center lasing wavelength ranging from 1025 nm to 1100 nm.

3. The self start, seed, mode locked fiber laser of claim 1, where the output laser pulse has a pulse repetition rate ranging from 50 kHz to 100 MHz.

4. The self start, seed, mode locked fiber laser of claim 1, where the output laser pulse has a spectrum bandwidth ranging from 0.5 nm to 30 nm.

5. The self start, seed, mode locked fiber laser of claim 1, where the output laser pulse has a pulse width ranging from 100 fs to 3 ns.

6. The self start, seed, mode locked fiber laser of claim 1, where the total length of the first single mode fiber, the second single mode fiber, and the third single mode fiber ranges from 1 m to 3000 m.

7. The self start, seed, mode locked fiber laser of claim 1, where the bandpass filter has a bandwidth ranging from 1 nm to 20 nm.

8. The self start, seed, mode locked fiber laser of claim 1, where the Ytterbium doped fiber has a doping concentration ranging from 10,000 ppm to 2,000,000 ppm.

9. The self start, seed, mode locked fiber laser of claim 1, where the WDM coupler is a 980/1060 coupler.

10. The self start, seed, mode locked fiber laser of claim 1, where the WDM coupler is a 980/1030 coupler.

11. The self start, seed, mode locked fiber laser of claim 1, where the in-line polarization beam splitter comprises a polarization splitter cube.

12. The self start, seed, mode locked fiber laser of claim 1, where the in-line polarization beam splitter comprises a birefringence crystal.

13. A high energy, ultra-short, mode locked fiber laser system comprising:
a seed laser comprising:
a pump laser;
a WDM coupler to couple the pump laser into a Ytterbium doped fiber, where the Ytterbium doped fiber is coupled into a first single mode fiber;
a bandpass filter coupled to the first single mode fiber output and to a second single mode fiber;
a first in-line polarization controller coupled to the second single mode fiber output and an in-line polarization beam splitter, where the in-line polarization beam splitter comprises a single mode fiber output and a polarization maintaining fiber output, where the polarization maintaining fiber is configured for an output laser pulse;
a polarization insensitive isolator coupled to the single mode fiber output of the in-line polarization beam splitter;
a second in-line polarization controller coupled to the polarization insensitive isolator and a third single mode fiber, where the third single mode fiber output is coupled into the WDM coupler
where the seed laser is configured to couple the output laser pulses to a preamplifier;
a high power amplifier coupled to the output of the preamplifier; and
a compressor coupled to the output of the high power amplifier.

14. The high energy, ultra-short, mode locked fiber laser system of claim 13, where the output laser pulse has a center lasing wavelength ranging from 1025 nm to 1100 nm.

15. The high energy, ultra-short, mode locked fiber laser system of claim 13, where the output laser pulse has a pulse repetition rate ranging from 50 kHz to 100 MHz.

16. The high energy, ultra-short, mode locked fiber laser system of claim 13, where the output laser pulse has a spectrum bandwidth ranging from 0.5 nm to 30 nm.

17. The high energy, ultra-short, mode locked fiber laser system of claim 13, where the output laser pulse has a pulse width ranging from 100 fs to 3 ns.

18. The high energy, ultra-short, mode locked fiber laser system of claim 13, where the total length of the first single mode fiber, the second single mode fiber, and the third single mode fiber ranges from 1 m to 3000 m.

19. The high energy, ultra-short, mode locked fiber laser system of claim 13, where the bandpass filter has a bandwidth ranging from 1 nm to 20 nm.

20. The high energy, ultra-short, mode locked fiber laser system of claim 13, where the Ytterbium doped fiber has a doping concentration ranging from 10,000 ppm to 2,000,000 ppm.

21. The high energy, ultra-short, mode locked fiber laser system of claim 13, where the WDM coupler is a 980/1060 coupler.

22. The high energy, ultra-short, mode locked fiber laser system of claim 13, where the WDM coupler is a 980/1030 coupler.

23. The high energy, ultra-short, mode locked fiber laser system of claim 13, where the in-line polarization beam splitter comprises a polarization splitter cube.

24. The high energy, ultra-short, mode locked fiber laser system of claim 13, where the in-line polarization beam splitter comprises a birefringence crystal.

25. A method for generating high energy, ultra-short laser pulses, the method comprising:
generating electromagnetic radiation from a pump laser;
coupling the pump laser electromagnetic radiation to a Ytterbium doped fiber using a WDM coupler;
coupling the output from the Ytterbium doped fiber to a first single mode fiber;
coupling a bandpass filter to the first single mode fiber output and to a second single mode fiber;
coupling a first in-line polarization controller to the second single mode fiber output and an in-line polarization beam splitter comprising a single mode fiber output and a polarization maintaining fiber output configured to emit an output laser pulse;
coupling a polarization insensitive isolator to the single mode fiber output of the in-line polarization beam splitter and to a second in-line polarization controller;
coupling a third single mode fiber output to the second in-line polarization controller and to the WDM coupler;
coupling the output laser pulse to a preamplifier;
coupling the preamplifier output to a high power amplifier; and
coupling the high power amplifier output to a compressor.
